(19) United States
(12) Patent Application Publication
(10) Pub. No.: US 2022/0383752 A1
(43) Pub. Date: Dec. 1, 2022

(54) VEHICLE CONTROL SYSTEM AND METHOD FOR CONTROLLING THE MOVEMENT OF A GROUP OF VEHICLES

(71) Applicant: Robert Bosch GmbH, Stuttgart (DE)

(72) Inventors: Soheil Gherekhloo, Lauffen Am Neckar (DE); Adwait Sanjay Kale, Ludwigsburg (DE)

(21) Appl. No.: 17/663,058

(22) Filed: May 12, 2022

(30) Foreign Application Priority Data
May 27, 2021 (DE) 10 2021 205 389.0

(51) Int. Cl. G08G 1/00; H04W 4/40; B60W 30/16

(52) U.S. Cl. CPC G08G 1/22; H04W 4/40; G08G 1/207; B60W 30/16; B60W 2556/65; B60W 2720/10; B60W 2754/30

(57) ABSTRACT

A vehicle control system for controlling the movement of a group of vehicles that includes at least a first vehicle, a second vehicle following the first vehicle, and a third vehicle which in turn follows the second vehicle, via vehicle data, present at least within the group of vehicles, for controlling the mutually dependent movement of the vehicles. The vehicle control system includes a control level with multiple control devices that utilize the vehicle data for influencing a state of movement of the vehicles in a first network topology, and a communication level with multiple communication devices that transmit the vehicle data between the vehicles in a second network topology. At least one of the network topologies is set as a function of the other network topologies and/or of a performance of and/or a requirement for the control level and/or communication level, during operation of the vehicles.

### CROSS REFERENCE

The present application claims the benefit under 35 U.S.C. § 119 of German Patent Application No. 10 2021 205 389.0 filed on May 27, 2021, which is expressly incorporated herein by reference in its entirety.

### FIELD

The present invention relates to a vehicle control system. Moreover, the present invention relates to a method for controlling the movement of a group of vehicles, a computer program, and a memory unit.

### BACKGROUND INFORMATION

German Patent Application No. DE 10 2019 210 643 A1 describes a method for operating vehicles of a line of vehicles. By use of the method, the intent is to uniformly increase a time interval between the vehicles of the line of vehicles. The line of vehicles includes a preceding vehicle, a vehicle following same, and a vehicle which in turn follows that vehicle. The time interval between the vehicles is uniformly increased in an automated manner via target speeds of the vehicles.

### SUMMARY

The present invention relates to a vehicle control system. The reliability and accuracy of the vehicle control system may thus be increased. The control level and the communication level may be adaptively and automatically adjusted to one another. As a result, the collective driving behavior of the group of vehicles may be made uniform, and a distance between the vehicles may be set more uniformly and the number of braking operations of the vehicles may be reduced. The driving safety of the group of vehicles is increased.

Movement control may be understood to mean a control, preferably automated control, of the vehicle movement, preferably a longitudinal movement, based on vehicle data, in particular by controlling the vehicle speed, preferably for maintaining the most uniform distance possible between the vehicles. The change in the vehicle movement may be implemented by an actuation of vehicle brakes and/or by an acceleration via at least one drive element. If a vehicle leaves the group of vehicles, for example by turning off from the route, the distance between the vehicles may subsequently be made uniform once again, in that the movement control changes the vehicle movement of the remaining vehicles in the group of vehicles.

A group of vehicles may be understood to mean multiple vehicles on the same route. The group of vehicles may be a column of vehicles or a convoy of vehicles. The group of vehicles may be a line of vehicles as a formation of vehicles traveling behind one another. The vehicles of the group of vehicles are free of a mechanical connection with one another. The vehicles of the group of vehicles may travel behind one another in a defined vehicle order via a so-called “electronic drawbar.” The group of vehicles may include more than three vehicles.

The first, second, and third vehicles may each be embodied as a motor vehicle, passenger vehicle, two-wheeled vehicle, or truck. The vehicle may include a drive element for moving the vehicle. The drive element may be embodied as an internal combustion engine and/or electric motor. The vehicle may be a semiautomated or fully automated vehicle, in particular with automation level 4 or 5 according to SAE Standard J3016. The vehicle may be embodied as a hybrid vehicle or electric vehicle.

The vehicle data may be used to control the mutually dependent movement of the vehicles. The vehicle data may be indirect or direct sensor data. The sensor data may be provided by a vehicle sensor. The vehicle sensor may be a LIDAR sensor, a radar sensor, an ultrasonic sensor, and/or a camera. In addition to the use for controlling movement, the vehicle data may also be used for other purposes.

At least two of the vehicles, preferably all vehicles, of the group of vehicles may in each case include at least one control device. The control device may be an ACC controller, preferably a CACC controller. “ACC” stands for adaptive cruise control, and “CACC” stands for cooperative adaptive cruise control. The control device may be connected to at least one vehicle component that changes the vehicle speed and/or the vehicle acceleration. The vehicle component may be a vehicle brake or a drive element. The vehicle component may be a control unit that, for example, indirectly or directly controls an operation of the vehicle brake and/or of the drive element.

Further processing of the vehicle data in the respective vehicle, which with the other vehicles forms the group of vehicles, may be understood as data usage of the vehicle data of the other vehicles. The further processing may be a computation, preparation, and/or output of the vehicle data, for example to the vehicle component.

At least two of the vehicles, preferably all vehicles, of the group of vehicles may in each case include at least one communication device. The communication device may carry out a Car2X communication, preferably a vehicle-to-vehicle (V2V) communication. For short distances, dedicated short-range communication (DSRC) via WLAN between the vehicles, in particular according to the 802.11standard, and/or via a mobile radio communications network, for example via a 5G mobile radio communications network, may preferably be used. For example, with DSRC, WLAN may contribute to traffic safety in structurally weak regions when there is an inadequate communication infrastructure, since WLAN has short delay times and small data volumes. The DSRC via mobile radio is typically also referred to as cellular vehicle-to-X (C-V2X).

The communication device may include a PC5 interface or a Uu interface.

The individual vehicle may include a control device and a communication device. The control device and the communication device may be connected to one another. The control device and the communication device may be situated at separate positions at the vehicle or spatially close to one another. The control device and/or the communication device may be fastened to the inside or the outside of the vehicle.

The first network topology may describe an interlinked setup of the control devices. The second network topology may describe an interlinked setup of the communication devices. An assembly of connections may be understood as an interlinked setup. The connections may include physical connections, for example via electromagnetic waves, in particular in the case of the second network topology. The connections may include information-based connections, for example in the case of the first network topology. An information-based connection may be understood to mean, for example, that a control device of one of the vehicles has vehicle data of a control device of one of the other vehicles.

The performance of the control level and/or communication level may refer to a processing performance, transfer performance, transfer quality, input quality, and/or output quality of the vehicle data. The performance of the communication level may be a function of the number of vehicles within the group of vehicles.

The requirement for the control level and/or communication level may refer to the conditions imposed on the network topology. For example, during the movement of the vehicles, there may be a requirement for the first vehicle to send a message to all subsequent vehicles of the group of vehicles.

The one network topology may be set prior to start-up, preferably prior to initial start-up; of the vehicle as a function of the other of the two network topologies. The one network topology may be settable before and during setup of the group of vehicles during the movement on the route. The one network topology may be set as a function of the currently present and/or expected, preferably estimated, in particular upcoming, performance of the control level and/or communication level.

In one preferred example embodiment of the present invention, it is advantageous when the first and/or second network topology are/is set for a lower dimension than a higher-dimensional first and/or second network topology that are/is settable for the movement, when the performance of the control level and/or of the communication level falls below a threshold value. The performance and the capacity of the control level and/or of the communication level may thus be taken into account, and a disadvantageous overload or insufficient capacity utilization may be avoided. The threshold value may denote a transfer quality, a setup, a transferable data volume, or the like.

If the network topology is set for a higher dimension, for the same number of units, for example control devices or communication devices, the interlinked setup may have more interconnections than for a lower-dimensional network topology, for example a line topology that has a one-dimensional design.

If the network topology is set for a lower dimension, for the same number of units, for example control devices or communication devices, the interlinked setup may have fewer interconnections than for a higher-dimensional network topology.

The first and/or second network topology may be set as a line topology, for example, when the performance of the control level and/or of the communication level falls below a threshold value. The first and/or second network topology may be set for a lower dimension than a highest-dimensional network topology that is settable in practice during the movement of the vehicle.

In one particular example embodiment of the present invention, it is advantageous when the first and/or second network topology are/is set for a higher dimension when the performance of the control level and/or of the communication level reaches and exceeds a threshold value. With regard to one of the vehicles, a higher-dimensional interlinked setup may include a connection to more than two vehicles of the group of vehicles.

In one preferred example embodiment of the present invention, it is provided that unidirectional and/or bidirectional connections are implemented in the first and/or second network topology. Solely unidirectional connections or solely bidirectional connections may be used in the network topology. A combination of unidirectional and bidirectional connections is also possible.

In one preferred example embodiment of the present invention, it is advantageous when the first network topology is set as a function of the second network topology. The first network topology may, for example, be adapted to the second network topology. However, the second network topology may also be set as a function of the first network topology. The second network topology may, for example, be adapted to the first network topology. For example, if more vehicle data are transmitted, via the communication level, to the respective vehicle than its control device is able to process, the communication level is unnecessarily burdened and its reliability in the data transfer may possibly be adversely affected, for example due to packet collisions of data packets occurring during the data transfer, which in particular result in a reduction of the transfer frequency.

In addition, a first network topology that is below a degree of interlinking of the second network topology may only insufficiently utilize the available vehicle data and may adversely affect the performance of the movement control.

In one preferred example embodiment of the present invention, it is provided that the first and/or second network topology are/is changeable during operation of the vehicle. The first and second network topologies may be adapted to one another prior to operation, in particular before use of the vehicle control system. In addition, during the movement of the group of vehicles, the first and/or second network topology may be adapted to the respective other of the two network topologies and/or adapted to the performance of the control level and/or of the communication level. The performance of the communication level may be a function, for example, of surroundings conditions of the group of vehicles.

In one particular example embodiment of the present invention, it is advantageous when the first network topology and second network topology are set equal to one another. In this way, the capacities of the control level and of the communication level may be matched to one another.

Also provided in accordance with an example embodiment of the present invention is a method for controlling the movement of a group of vehicles that includes at least a first vehicle, a second vehicle following the first vehicle, and a third vehicle which in turn follows the second vehicle, using a vehicle system that includes at least one of the above features, at least one of the network topologies being set as a function of the other of the two network topologies and/or of a performance of the control level and/or of the communication level, at least during operation of the vehicle.

Also provided in accordance with an example embodiment of the present invention is a computer program that includes machine-readable instructions that are executable on at least one computer, the above-described method running when the instructions are executed, and a memory unit that is designed to be machine-readable and accessible by at least one computer, and on which this computer program is stored.

Further advantages and advantageous embodiments of the present invention result from the description of the figures.

### BRIEF DESCRIPTION OF THE DRAWINGS

The present invention is described in greater detail below with reference to the figures.

FIG. 1 shows a group of vehicles that includes three vehicles.

FIG. 2 shows a network topology of a vehicle control system in one particular specific example embodiment of the present invention.

FIG. 3 shows various network topologies in further specific example embodiments of the present invention.

### DETAILED DESCRIPTION OF EXAMPLE EMBODIMENTS

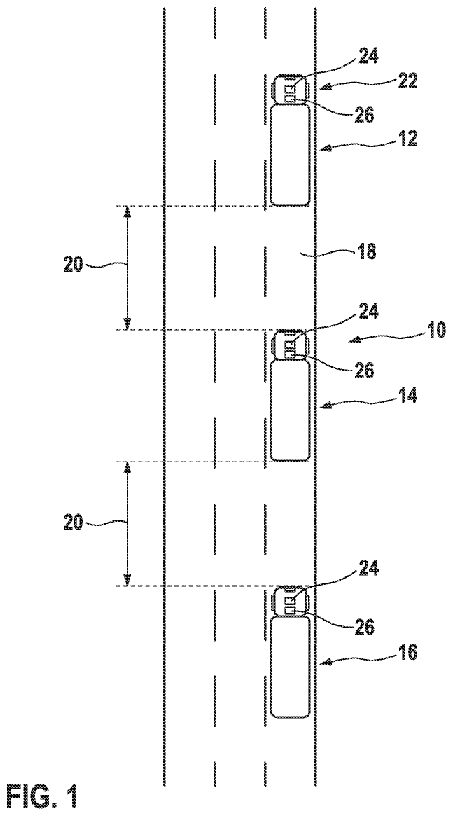

FIG. 1 shows a group of vehicles 10 that includes three vehicles. Group of vehicles 10 includes a first vehicle 12, a second vehicle 14 following the first vehicle, and a third vehicle 16 in turn following the second vehicle, all of which are traveling on the same route 18. Vehicles 12, 14, 16 of group of vehicles 10 are free of a mechanical connection with one another, and are intended to maintain a predefined distance 20 from one another in order to meet the safety requirements. Predefined distance 20 may be a function of a vehicle speed of vehicles 12, 14, 16.

Group of vehicles 10 includes a vehicle control system 22, which for example for second vehicle 14 includes a control device 24 and a communication device 26. Control device 24 is configured to process vehicle data of second vehicle 14, for example the vehicle speed of second vehicle 14, an accelerator pedal position, a brake pedal position, a steering angle, a distance 20 from preceding first vehicle 12, and the like, as well as further vehicle data from first and/or third vehicle(s) 12, 16. The vehicle data are used to control the mutually dependent movement of vehicles 12, 14, 16 in order to maintain the most uniform distance 20 possible between vehicles 12, 14, 16.

Control device 24 is preferably connected to at least one vehicle component that influences the vehicle speed and/or the vehicle acceleration of second vehicle 14, for example connected to a control unit of second vehicle 14 that is able to control a drive element for moving second vehicle 14, for example an internal combustion engine, and/or vehicle brakes. In this way, control device 24 may control the movement of second vehicle 14 via the vehicle data.

Communication device 26 of second vehicle 14 allows the communication with first and third vehicles 12, 16 for transferring the vehicle data. Communication device 26 may carry out a Car2X communication, preferably a vehicle-to-vehicle (V2V) communication. For short distances, dedicated short-range communication (DSRC) via WLAN may preferably be used between vehicles 12, 14, 16, in particular according to the 802.11p standard, and/or via a mobile radio communications network, for example via a 5G mobile radio communications network.

In addition, first and third vehicles 12, 16 may have the same type of control device 24 and communication device 26 as for second vehicle 14.

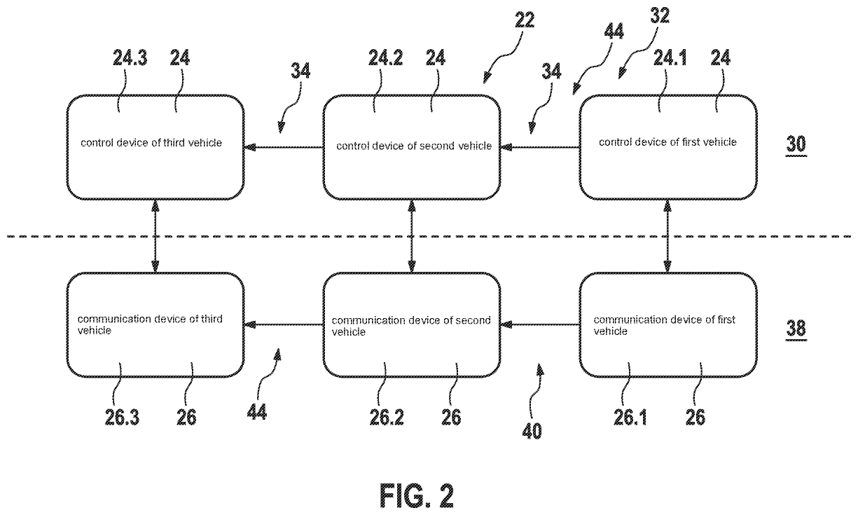

FIG. 2 shows a network topology of a vehicle control system 22 in one particular specific embodiment of the present invention. Control devices 24 of vehicle control system 22 are associated with a control level 30 having a first network topology 32.

First network topology 32 describes a setup of data usage 34, based on the respective vehicle, of the vehicle data of the other vehicles. Communication devices 26 of vehicle control system 22 are associated with a communication level 38 having a second network topology 40. Second network topology 40 describes a setup of data link 42, based on the respective vehicle, with the other vehicles.

Control device 24.2 of the second vehicle is connected to communication device 26.2 of the second vehicle. Communication device 26.2 may obtain and transmit the vehicle data that are output by control device 24.2. In addition, communication device 26.2 may output received vehicle data to control device 24.2. The same setup applies for control device 24.1 and communication device 26.1 of the first vehicle, and control device 24.3 and communication device 26.3 of the third vehicle.

First network topology 32 is designed as line topology 44 in which control device 24.3 processes vehicle data of control device 24.2, and control device 24.2 processes vehicle data of control device 24.1.

Second network topology 40 has a design that is dependent on first network topology 32, and is likewise designed as line topology 44. In this way, the performance and the capacity of second network topology 40 may be adapted to the performance and capacity of first network topology 32. Conversely, first network topology 32 may be set as a function of second network topology 40.

If first network topology 32 is a line topology 44 as depicted here, the individual vehicle, for example the second vehicle with control device 24.2, utilizes the vehicle data of the preceding and/or following vehicle(s), here in particular the vehicle data of control device 24.1 of the preceding first vehicle. If second network topology 40 is designed as line topology 44, the individual vehicle, for example communication device 26.2, is connected to the respective preceding and/or following vehicle(s), here in particular to communication device 26.1 of the preceding first vehicle, for receiving the vehicle data.

It is preferably provided that first and/or second network topology 32, 40 are/is set as a function of the performance of control level 30 and/or of communication level 38. In this way, the performance and the capacity of control level 30 and/or of communication level 38 may be taken into account in the design of first and/or second network topology 32, 40, and a disadvantageous overload or insufficient capacity utilization may be avoided.

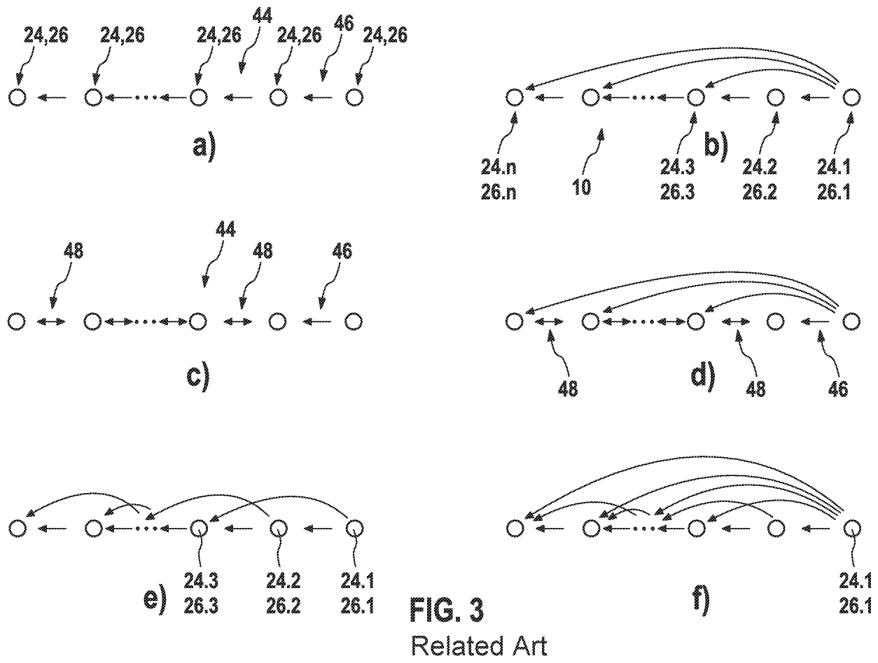

FIG. 3 shows various network topologies in further specific embodiments of the present invention. The network topologies illustrated here may be used both for the control level and for the communication level. FIG. 3a) depicts a line topology 44 with unidirectional connections 46, i.e., a unidirectional usage of the vehicle data of control devices 24 between the vehicles for the control level, or a unidirectional connection 46 between communication devices 26 of the vehicles for the communication level.

FIG. 3b) depicts a multidimensional network topology in which the network topology is higher-dimensional. “Higher-dimensional” preferably refers to a setup of the network topology which with regard to a vehicle has more connections with respect to the other vehicles than in the case of the line topology. For example, control device 24.3 or communication device 26.3 of the third vehicle utilizes or receives vehicle data of control device 24.2 or of communication device 26.2 of the preceding second vehicle, and of control device 24.1 or of communication device 26.1 of the first vehicle, which in turn precedes the second vehicle. Control device 24.n or communication device 26.n of the last vehicle of the n vehicles in group of vehicles 10 utilizes or receives the vehicle data of the vehicle immediately preceding it, i.e., the next to last vehicle, and of the first vehicle.

FIG. 3c) illustrates a line topology 44 as in FIG. 3a), except here with bidirectional connections 48 between the vehicles and a unidirectional connection 46 between the first vehicle and second vehicle.

FIG. 3d) shows a network topology as in FIG. 3b), which is higher-dimensional and in addition has interlinking bidirectional connections 48, and between the first vehicle and second vehicle has a bidirectional connection 46 as in the network topology from FIG. 3c).

The network topology shown in FIG. 3e) has a higher-dimensional design in which the respective vehicle, for example control device 24.3 or communication device 26.3 of the third vehicle, utilizes or receives the vehicle data of control device 24.2 or of communication device 26.2 of the preceding second vehicle, and utilizes or receives the vehicle data of control device 24.1 or of communication device 26.1 of the first vehicle, which in turn precedes the second vehicle.

FIG. 3f) shows a network topology having a higher-dimensional design, and in which the respective vehicle, in an expansion of the setup from FIG. 3e), additionally utilizes or receives the vehicle data of control device 24.1 or of communication device 26.1 of the first vehicle.

What is claimed is:

1. A vehicle control system for controlling movement of a group of vehicles that includes at least a first vehicle, a second vehicle following the first vehicle, and a third vehicle which follows the second vehicle, via vehicle data, present at least within the group of vehicles, for controlling the mutually dependent movement of the vehicles, the vehicle control system comprising:
a control level with multiple control devices that utilize the vehicle data for influencing at least one state of movement of the vehicles in a first network topology that describes a setup of a data usage, based on a respective vehicle of the vehicles, of the vehicle data of the other vehicles; and
a communication level with multiple communication devices configured to transmit the vehicle data between the vehicles in a second network topology that describes a setup of a data link, based on a respective vehicle of the vehicles, with the other vehicles;
wherein at least one of the first and second network topologies is set as a function of the other of the first and second network topologies and/or of a performance of and/or a requirement for the control level and/or communication level, at least during operation of the vehicles in the group of vehicles.

2. The vehicle control system as recited in claim 1, wherein the first and/or second network topology is set for a lower dimension than a higher-dimensional first and/or second network topology that is settable for the movement, when a performance of the control level and/or of the communication level falls below a threshold value.

3. The vehicle control system as recited in claim 1, wherein the first and/or second network topology is set for a higher dimension when a performance of the control level and/or of the communication level reaches and exceeds a threshold value.

4. The vehicle control system as recited in claim 1, wherein unidirectional and/or bidirectional connections are implemented in the first and/or second network topology.

5. The vehicle control system as recited in claim 1, wherein the first network topology is set as a function of the second network topology.

6. The vehicle control system as recited in claim 1, wherein the first and/or second network topology is changeable during operation of the vehicle.

7. The vehicle control system as recited in claim 1, wherein the first network topology and second network topology are set equal to one another.

8. A method for controlling movement of a group of vehicles that includes at least a first vehicle, a second vehicle following the first vehicle, and a third vehicle which follows the second vehicle, via a vehicle control system, the vehicle control system including a control level with multiple control devices that utilize the vehicle data for influencing at least one state of movement of the vehicles in a first network topology that describes a setup of a data usage, based on a respective vehicle of the vehicles, of the vehicle data of the other vehicles, and a communication level with multiple communication devices configured to transmit the vehicle data between the vehicles in a second network topology that describes a setup of a data link, based on a respective vehicle of the vehicles, with the other vehicles, the method comprising:
setting, during operation of a respective vehicle of the vehicles, at least one of the first and second network topologies as a function of the other of the first and second network topologies and/or of a performance of the control level and/or of the communication level, at least during operation of the vehicle.

9. A machine-readable memory unit on which is stored a computer program including machine-readable instructions for controlling movement of a group of vehicles that includes at least a first vehicle, a second vehicle following the first vehicle, and a third vehicle which follows the second vehicle, via a vehicle control system, the vehicle control system including a control level with multiple control devices that utilize the vehicle data for influencing at least one state of movement of the vehicles in a first network topology that describes a setup of a data usage, based on a respective vehicle of the vehicles, of the vehicle data of the other vehicles, and a communication level with multiple communication devices configured to transmit the vehicle data between the vehicles in a second network topology that describes a setup of a data link, based on a respective vehicle of the vehicles, with the other vehicles, the machine-readable instructions, when executed by a computer, causing the computer to form:
setting, during operation of a respective vehicle of the vehicles, at least one of the first and second network topologies as a function of the other of the first and second network topologies and/or of a performance of the control level and/or of the communication level, at least during operation of the vehicle.
